(19) United States
(12) Patent Application Publication
(10) Pub. No.: US 2015/0198974 A1
(43) Pub. Date: Jul. 16, 2015

(54) MULTIMEDIA INFORMATIONAL DECK

(71) Applicant: Steve Hill, Houston, TX (US)

(72) Inventor: Steve Hill, Houston, TX (US)

(21) Appl. No.: 14/668,760

(22) Filed: Mar. 25, 2015

Related U.S. Application Data
(63) Continuation-in-part of application No. 13/672,216, filed on Nov. 8, 2012, now Pat. No. 9,009,999.
(60) Provisional application No. 61/560,660, filed on Nov. 16, 2011.

(51) Int. Cl. G06F 1/16; G06F 17/30; G06F 1/18

(52) U.S. Cl. CPC G06F 1/1615; G06F 1/1637; G06F 1/1684; G06F 1/18; G06F 17/30864

(57) ABSTRACT

A method of identifying risk at a job site, the method comprising tracking the requests for content from multiple field devices having processors and software to a server and creating a record of requests. Then using a server to decide if the request meets a threshold level and if yes reporting an alert to a supervisor's computing device.

### REFERENCE TO RELATED APPLICATIONS

This application is a Continuation in Part (CIP) of U.S. patent application Ser. No. 13/672,216 filed Nov. 8, 2012, which claims the full Paris Convention priority to U.S. provisional application 61/560,660, filed on Nov. 16, 2011, the contents of both are incorporated by this reference, as if fully set forth herein in their entirety.

### FIELD

This disclosure relates to a self-contained movable group of placards.

### GENERAL BACKGROUND

Information Articles are known in the art; U.S. Pat. No. 3,950,871 illustrates a cassette book.

Having information available in a contained and organized book may be useful for many industries, wherein such information may be operational or educational.

### DESCRIPTION

Traditional methods which have been utilized for providing contained or connected informational pages such as those shown in U.S. Pat. No. 3,950,871 lack physical orientation reference.

According to some exemplary implementations, devices, systems, and methods of the present disclosure are directed to a self-contained group of cards or placards rotatable along a common axis. In some aspects, said group fits within the boundaries of a fixed front and back wall and a tactile cue is provided on at least one wall to identify front or back.

According to some exemplary implementations, devices, systems, and methods of the present disclosure are directed to a self-contained group of cards or placards rotatable along a common axis. In some aspects, said group fits within the boundaries of a fixed front and back wall at least one portion of at least one of said front and said back wall is extended to provide a physical cue to proper orientation.

According to some exemplary implementations, devices, systems, and methods of the present disclosure are directed to a self-contained group of interior cards or placards rotatable along a common axis. In some aspects, said group fits within the boundaries of a fixed front and back wall and a wall extension beyond the interior card diameters and outside the rotational pathway of said interior cards forms a finger hold to secure said group of cards or placards, wherein interior cards may be rotated while the user firmly grips the extended corner. Having a firm hand grip may reduce at least one of finger injury, and/or wear and tear on the deck, placards, and the rotational mechanism.

According to some exemplary implementations, devices, systems, and methods to improve a deck of rotatable cards include providing physical cues to position a deck of informational placards in a desired position (i.e. front forward). Whereby a textured surface on at least one side of a deck provides a physical cue for positioning.

According to some exemplary implementations, devices, systems, and methods provide physical cues on a finger grab to position a deck of informational placards in a desired position (i.e. front forward). Whereby a textured surface on at least one side of a deck provides a physical cue for positioning.

According to some exemplary implementations, devices, systems, and methods disclosed is a deck with a plurality of informational cards movably connected to each other via a spline and having an electronic media display card (EMDC) with a first cover and a second cover connect to the spline; a display is fixed within a cavity in the core of the EMDC; the display's face is visible through the front cover of the EMDC. At least the following electronic components are fixed in the core of the EMDC, wiring, a battery processor Memory, controls and on/off switch; and, wherein said display is connected via electrical wiring to the battery, processor, memory, controls and a fingerprint reader.

In some instances the deck has at least one of the following additional electrical components, radio and antennae, Wi-Fi chip, GPS chip and RFID. In some instances the deck also has at least one of the following additional electrical components, microphone and emergency “911” button. In some instances the deck also has at least one of the following additional electrical components, ear jack, power input, and wired data I/O. In some instances the deck has at least one of the following additional electrical components, a second battery and removable memory card.

According to some exemplary implementations, devices, systems, and methods disclosed is a deck with a plurality of informational cards movably connected to each other via a spline and having an electronic media display card (EMDC) with a first cover and a second cover connect to the spline; a display is fixed within a cavity in the core of the EMDC; the display's face is visible through the front cover of the EMDC. The deck has a video graphics card and at least the following electronic components are fixed in the core of the EMDC, wiring, a battery processor Memory controls and on/off switch; and, wherein said display is connected via electrical wiring to the battery, processor, memory and controls.

The above described decks having an EDMC, in some instances will have an Electronic Paper Display.

According to some exemplary implementations, disclosed are devices, systems, and methods for identifying risk at a job site, including tracking the requests for content from multiple field devices to a server and creating a record of each request; filtering the requests for key words and specific topics; and, reporting occurrence of key word or pre-selected topic request. In some instance the method further comprising search a look-up table for key words and topics which should be reported. In some instance the method further comprising only reporting keyword or topic occurrences if the number of content requests exceeds a threshold level.

### DRAWINGS

The above-mentioned features and objects of the present disclosure will become more apparent with reference to the following description taken in conjunction with the accompanying drawings wherein like reference numerals denote like elements and in which:

FIG. 1A shows and assembly view of an exemplary implementation of a rotatable deck.

FIG. 1B shows a user holding the rotatable deck of FIG. 1A.

FIG. 1C shows an alternate exemplary cover for a rotatable deck.

FIGS. 2A-2C show sequential view of an exemplary implementation of a deck with a card rotated into a view orientation.

FIG. 3 shows a view of an exemplary implementation of a rotatable deck.

FIG. 4 shows a view of an exemplary implementation of a rotatable deck.

FIG. 5 shows a pocket stored rotatable deck.

FIGS. 6A-6C shows a rotatable deck with a media display.

FIGS. 7A and 7B shows a deck with media display.

FIGS. 8 is a is a diagram of a control scheme for an electronic deck

FIG. 9 is a flow diagram of some aspects of an electronic deck.

FIG. 10 shows a rotating and flipping informational deck with electronic display and static cards.

### FURTHER DESCRIPTION

Some of the informational decks disclosed herein provided printed data, some have RFID tags, some have GPS location, others have media displays, controllers, processors, memory and battery power supply. Some provide “911” emergency contact via signal communication.

In the following description of examples of implementations, reference is made to the accompanying drawings that form a part hereof, and which show, by way of illustration, specific implementations of the present disclosure that may be utilized. Other implementations may be utilized and structural changes may be made without departing from the scope of the present disclosure.

It is appreciated by those skilled in the art that some of the circuits, components, modules, and/or devices of the system disclosed in the present application are described as being in signal communication with each other, where signal communication refers to any type of communication and/or connection between the circuits, components, modules, and/or devices that allows a circuit, component, module, and/or device to pass and/or receive signals and/or information from another circuit, component, module, and/or device. The communication and/or connection may be along any signal path between the circuits, components, modules, and/or devices that allows signals and/or information to pass from one circuit, component, module, and/or device to another and includes wireless or wired signal paths. The signal paths may be physical such as, for example, conductive wires, electromagnetic wave guides, attached and/or electromagnetic or mechanically coupled terminals, semi-conductive or dielectric materials or devices, or other similar physical connections or couplings. Additionally, signal paths may be non-physical such as free-space (in the case of electromagnetic propagation) or information paths through digital components where communication information is passed from one circuit, component, module, and/or device to another in varying analog and/or digital formats without passing through a direct electromagnetic connection. These information paths may also include analog-to-digital conversions (“ADC”), digital-to-analog (“DAC”) conversions, data transformations such as, for example, fast Fourier transforms (“FFTs”), time-to-frequency conversations, frequency-to-time conversions, database mapping, signal processing steps, coding, modulations, demodulations, etc.

Computing devices may be computers, laptops, smart phones, tablets and devices with processors and memory in them with hardware supporting signal communication with other computing devices and networks.

Such device may have fingerprint readers built-in, voice recognition as security software therein.

Informational decks are useful, especially in field operations, wherein a user who is at a job, job site or other location and responsible for a function or job is provided with a durable compact deck of information cards to refer to as necessary to obtain information related to the job or task they are assigned to. Job site use of the deck of cards is a process and method wherein workers, users and the like have instant access to important information to perform their duties. In some instances the tracking of field deck use and requests for information from an electronic field deck is used for early identification of problems, trends and risks.

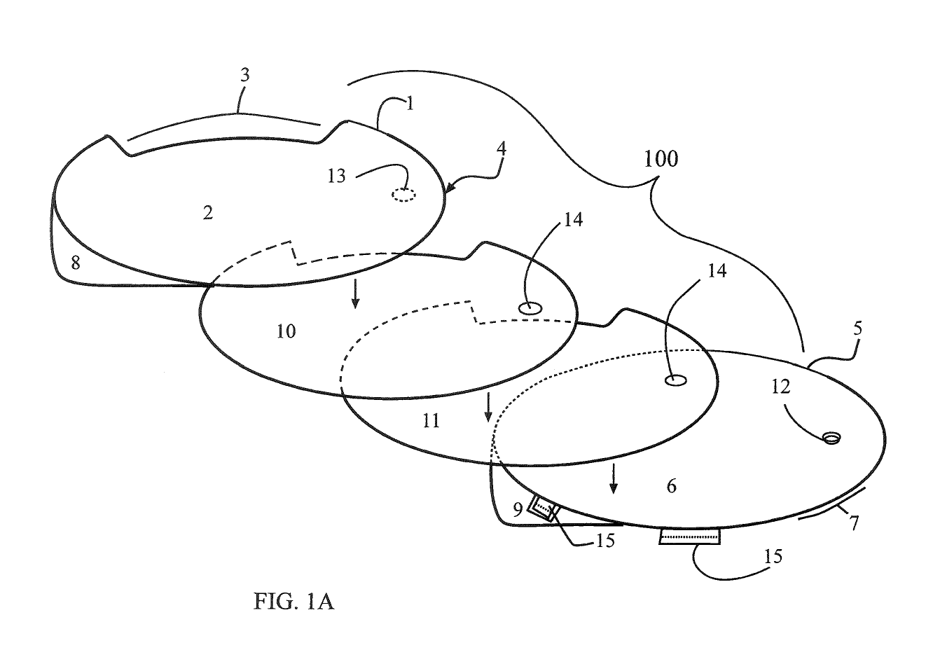

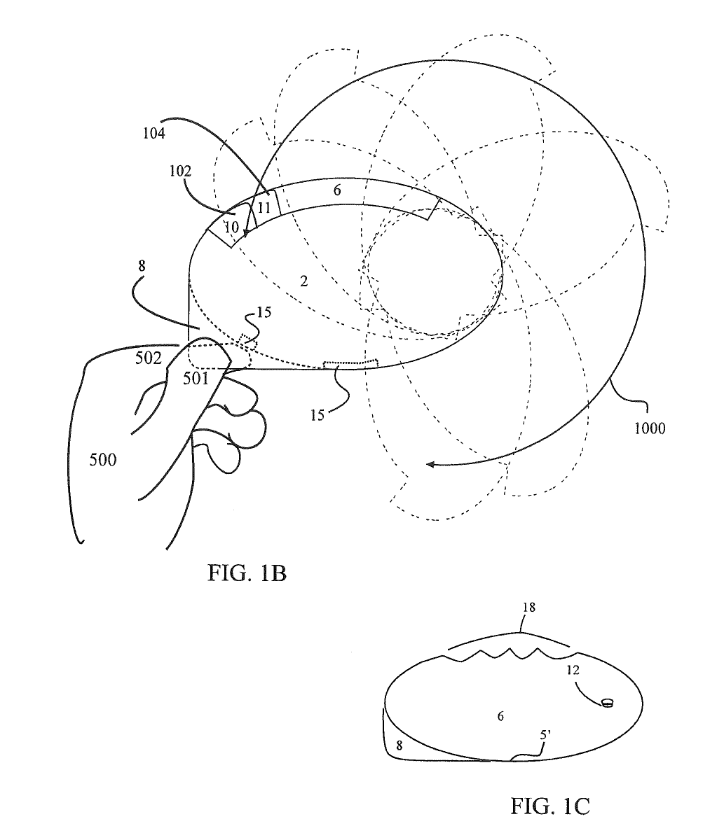

FIG. 1A shows aspects of a rotatable deck 100 and a system and method to provide a gripping surface remote from rotating cards. The deck shown in FIG. 1A is in an exploded assembly view. A deck of rotatable cards is formed. Said deck having a substantially planar top cover 1 is indicated having an interior face (not shown) and exterior face 2 a card selection window 3 and a circumference 4; a substantially planar back cover 5 is indicated having an interior face 6 and exterior face (not shown) and a circumference 7 and, a plurality of cards. Cards (may be referred to herein as pages and placards). Each of said top cover and back cover shown in FIGS. 1A-1C sandwich said cards. To maximize the viewable area of each card the cards are only slightly smaller than the top and back cover.

Extended from the top cover 1 is a front finger grab 8. The extended finger grab is extended outside the perimeter of the cards when the deck is closed. The front finger grab 8 is also positioned outside the rotational pathway 1000 of cards as shown in FIG. 1B. Extended from the bottom cover 5 is a back finger grab 9. The extended finger grab is extended outside the perimeter of the cards when the deck is closed. The back finger grab 9 is also positioned outside the rotational pathway of cards as shown in FIG. 1B. Those of ordinary skill in the art will recognize that it is within the scope of this disclosure that either one or both finger grabs may be deployed. Moreover it is also within the scope of the disclosure that said finger grab(s) may be out of plane with said top and back cover. Said finger grab(s) may also in some instances be contoured with bumps, divots and bends as opposed to planar.

Further the surface of said finger grab(s) may be different than said cover or cards. In some instance the grab surface may be sticky. In some instances a series of raised and coated bumps may be on said finger grab(s). Coatings may include rubberized material or vinyl or tacky. In some instance the grab(s) may be rougher than the exterior surfaces of the covers, in some instances said exterior of the finger grab(s) may be covered with or include additional layers or covers such as Velcro® foam or the like.

In yet other instances at least one of an edge of a card, a cover or a portion thereof may be mirrored or support a reflective material.

FIG. 1C shows aspects of an alternate back cover 5′ wherein a back window 18 is formed to provide additional access to the rotatable card.

Rotation is of cards is guided about pivot 12. Pivot 12 may be formed on the interior face 6 of the back 5 or a pivot 13 may be formed on the interior face of the top or on both top and back. Formed in each card is pivot guide 14 where through passes said pivot. At least a portion of the edge at the periphery 4 and 7 of the top and bottom covers can be separated, connected and/or supported via a tab-like wall structure. In the current implementation formed from one of said covers but which those of ordinary skill in the art will understand to include a discreet bridge between each cover also. Adhesive can be used to affix said tab or wall. Tabs 15 are shown extended from said periphery of at least one cover and bent and glued to connect from one cover to another. Such tab and clue assembly devices and methods are known in the art and therefore not described in greater detail.

When the device 100 is assembled and in a closed position a series of sequentially positioned leading edges corresponding to the rotatable cards are viewable through window 3 of the top cover 10. The first card 10 presents grab tab 102 which is in front of the second card 11. The second card presents a grab tab 104

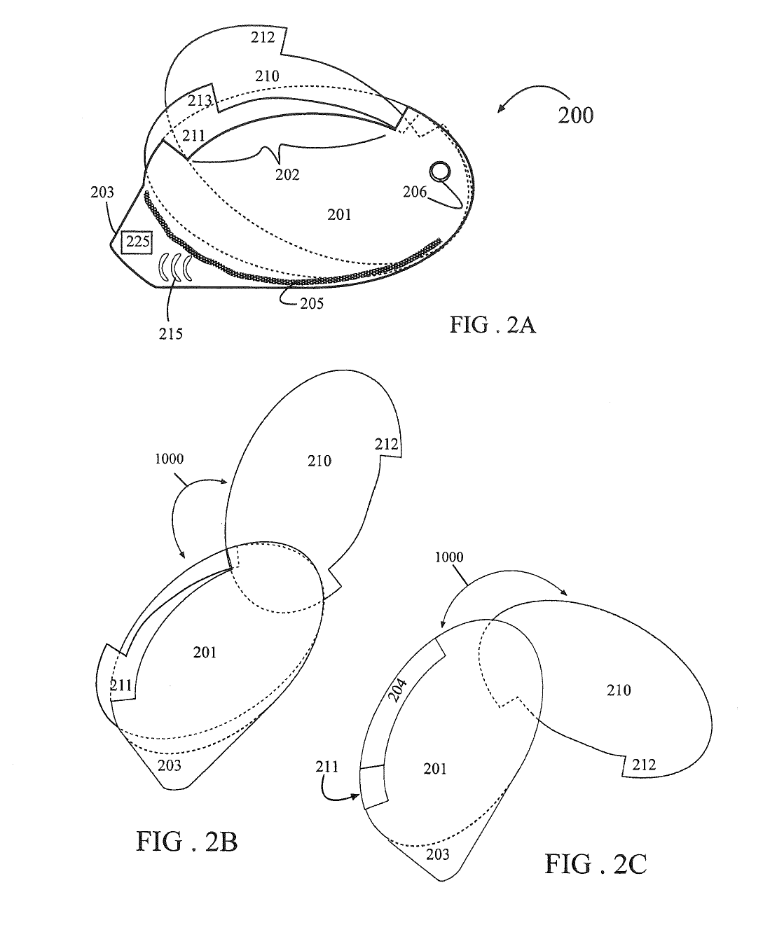

FIGS. 2A-2C show exemplary implementations of a deck with rotatable cards. It is required that the finger grab(s) extend in an orientation which do not interfere with the rotation of the cards from between the covers nor the position of the cards once rotated, nor the viewing of rotated card as shown in FIGS. 2A-2C. In the absence of finger grabs a user would necessarily be required to hold a rotatable deck by applying a force or pressure on the covers, the rotating means, and the cards. Damage to the rotating means or in inability to rotate out cards could prevent efficient use of the deck.

To utilize said finger grab(s), a user's hand 500 clasps the finger grab(s) between at least a thumb 501 and a finger which may include a forefinger 502. The cards are rotated around the pivot generally along the path of line 1000.

Shown in FIGS. 2A-2C are exemplary implementations of a system of rotatable placards 200. A generally planar front cover 201 with a window 202 and a finger grab 203 is affixed to a rear cover 204 via an affixing means at or about a portion of the periphery of the covers (generally within at least a portion of region 205) whereby said affixing means does not interfere with the rotational movement of placards. A rotational support means 206 such as a pivot, bearing, post, or the like is interposed between the interior faces of said front and said rear covers. One or more placards are rotatably mounted to said rotational support means via guides. Placards 210 and 211 are shown in FIGS. 2A-2C. The illustration of two placards is not indicative of the minimum or maximum number of placards within the scope of this disclosure.

Said placards are stacked. To provide for visual identification of each card when the deck 200 is closed each placard has a staged tab. The backmost placard has the tab which extends the greatest length across the window, with the next placard in sequence having a shorter tab and so on. Placard 210 is illustrated as the bottom placard. Tab 212 extended from placard 210 extends a greater length in window 202 than tab visible through window 202. The top placard 211 has tab 213 which is of a shorter length than tab 212. When closed a user can visually see both tab 212 and tab 213 and thereby make a selection. A texture such as raised bump 215, rail and the like, to define a region of the deck, such as the finger grab are illustrated in FIG. 2A.

Those of ordinary skill in the art will recognize that this disclosure also contemplates and teaches the use of divots, slots, holes, wells or other textures upon at least one of a finger grab and a front or back side of a deck, to provide physical positional cues.

Finger grab 203 is shown in FIG. 2A supporting a RFID chip 225. In addition to an RFID, the finger grab may support and or integrate other useful items such as led flashlight with button battery, whistle, reflector, knife (or small cutting blade) and a ruler may be formed on an edge. A QR code 230 may be added to one or more pages wherein additional information on a topic may be access via a smart phone by scanning or optically recognizing the QR code and the being directed via signal communication to a website or database that provides the information which can then be displayed on such a smart phone.

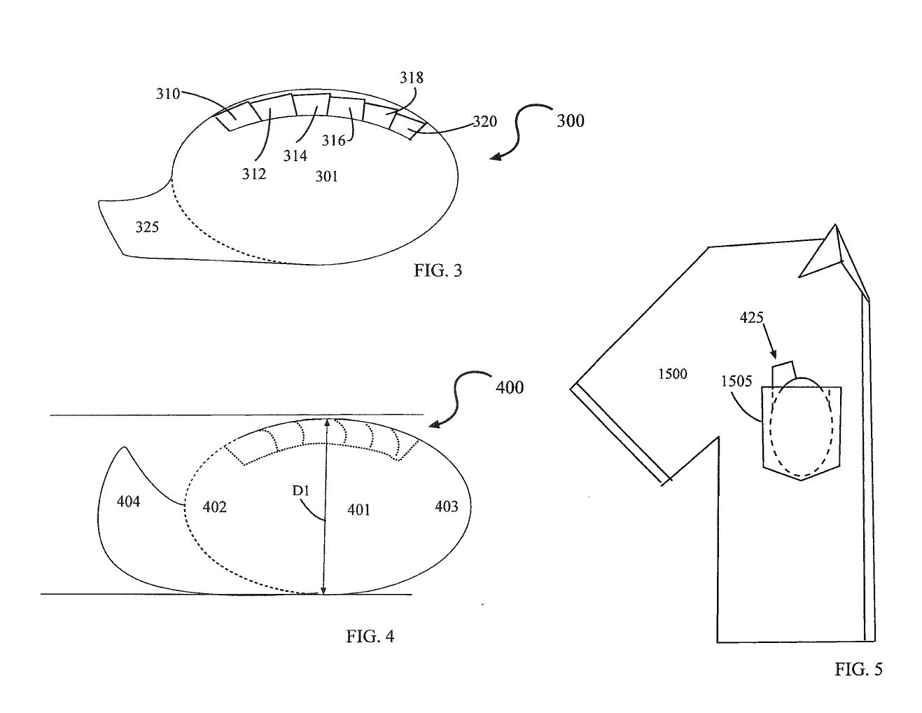

FIG. 3 illustrates an exemplary implantation of a rotatable deck 300. The rotatable deck is formed in generally the same fashion as the previously described exemplary implementations. A series of cards are stored beneath a top cover 301 and a bottom cover (not shown) and a pivoting means is provided between the covers whereby said cards may be rotated out for viewing and rotated back for storing. Tabs 310, 312, 314, 316, 318 and 320 each are extended from a card (cards not shown). A long finger grab 325 is also attached and extended from one or both covers. Said finger grab is oriented to not interfere with movement of said cards. The long finger grab provides a greater surface to hold onto or to support peripheral items such as information, textured surface(s), RFID, reflectors and the like.

FIG. 4 illustrates an exemplary implantation of a rotatable deck 400. The rotatable deck is formed in generally the same fashion as the previously described exemplary implementations. A series of cards are stored beneath a top cover 401 with a first curved end 402 and a second curved end 403 and a bottom cover (not shown) and a pivoting means is provided between the covers whereby said cards may be rotated out for viewing and rotated back for storing. Tabs are extended from a card (not shown). A large finger grab 404 is also attached and extended from one or both covers. The height diameter D1 of the deck 400 is utilized in this implementation as a limit on the maximum diameter of said finger grab(s). Setting a maximum diameter assure that the deck 400 can fit into a specific size holder such as a shirt 1500 pocket 1505 as shown in FIG. 5 but the extended long finger grab 425 is easily accessible, even with gloves on the hands of the user. Said finger grab is oriented to not interfere with movement of said cards. The long finger grab 425 provides a greater surface to hold onto or to support peripheral items such as information, textured surface(s), RFID, reflectors and the like.

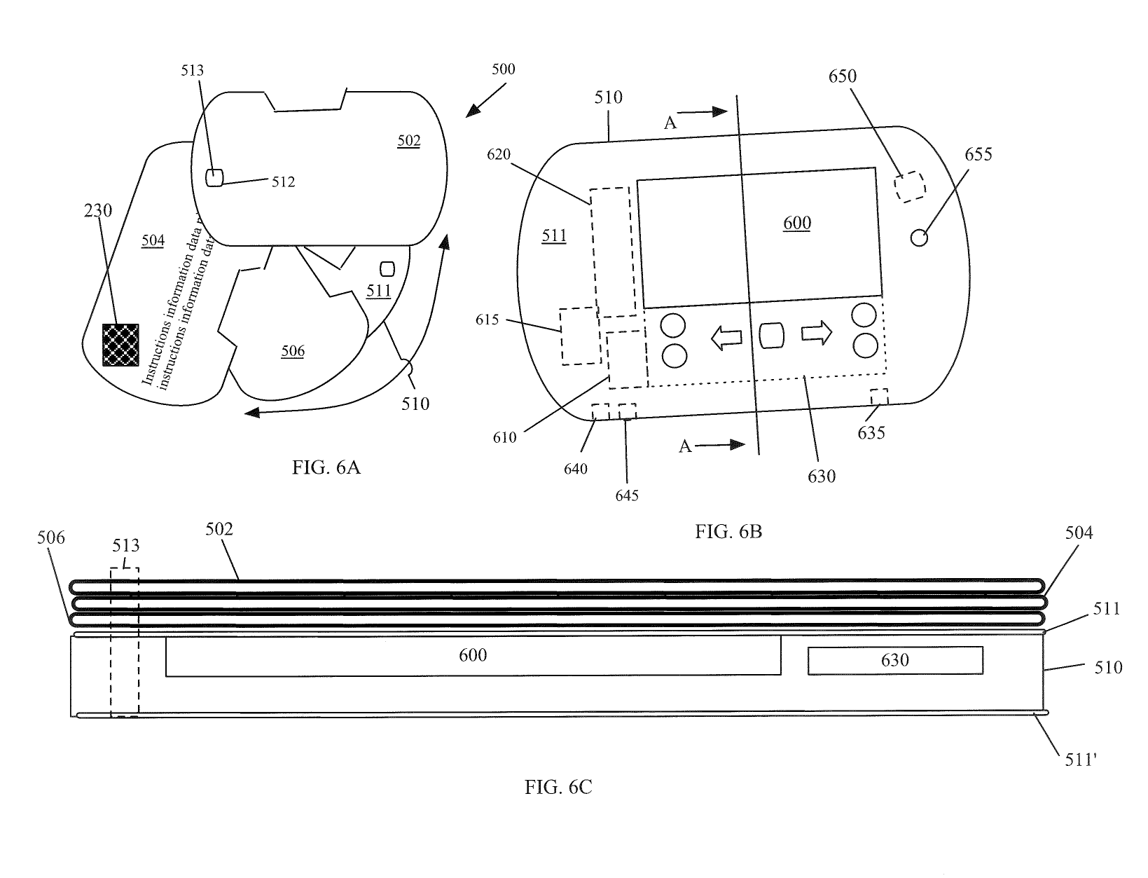

FIG. 6A-6C show a rotatable deck 500 having a series of card or pages 502-510. Electronic media display card (EMDC) 510 provides support for electronics and a display within one or more cavities 550 and also has at least one of a cover laminate which may be paper, film, sticker or the like is adhered or otherwise mounted to cover the cavities. If the cavity or cavities 550 is through both sides of the core 511″ then both the front side 511″A of the core and the back side 511″B are covered, if the cavity does not extend through both sides only the open side need be covered. Each card has a pivot guide 512 and a pivot 513 which they spin around. Card 510, the media card, provides supports a visual display 600. The visual display has a display face 600′ to view content and it may be a liquid crystal display, a passive display, reflective, backlit or active. It may be an e-ink (electronic ink) screen also referred to as electrophoretic which is the optical component of a film used in Electronic Paper Displays (EPD). Such ink is commonly referred to as “bistable”. Bistable ink will retain an image on an E Ink screen even when all power sources are removed. E-ink has very low power consumption compared to other flat display types. Card 510 is thick enough to hold the display and other electronic components and has cavities to hold the display 600, wiring, at least one processor/controller 610, memory 615, a battery supply 620, optionally a finger print reader 622, and control interface 630. The electrical components are wired together in a manner well known in the art. Additional, optional components include an, earphone jack 635, remote battery supply plug in or recharge plug-in 640, I/O such as a USB 645 to add software to the memory and/or download data from the memory and a camera 650 with a shutter switch 655. A front cover 511 and/or a back cover 511′ is added over the core 511″ of the media card 510 to seal in the electrical components. The cavities are of a size and shape to hold selected components. The cover or covers 511 and 511′ may be used to hold the components within the cavities. A laminate or sticker allows the cover to be easily changed and/or removed or replaced as necessary. In some instances a video graphics card 658 which will include a processor and memory suitable for video display may be include if video images are to be displayed on the display.

In field use the device is provided to one or more employees, first responders, subordinates or field persons and said field unit contains information deemed important, useful or necessary to them by the employer, supervisor, superior or client. The deck provides printed or “fixed” information and it also provides digital media information which is “variable” or “dynamic”. The display can show a user or operator text, pictures, diagrams and in some cases video images. The fixed information on the deck is useful to provide simple important information in a non-changing form that will remain available in the absence of battery power. However, the display is advantageous when information needs to be updated and changed, or the information is too extensive for a printed card, or the user may have limited language skills in the printed language. Additionally, via headphone or ear piece jacks the user can receive audio information, instructions or communication. A microphone may be added whereby user may communicate wirelessly to a base, control person, supervisor or the like. The radio function may be analog or digital. The deck may be updated wirelessly or via a wired connection to change or augment the content stored in memory for audio or visual or audio/visual display

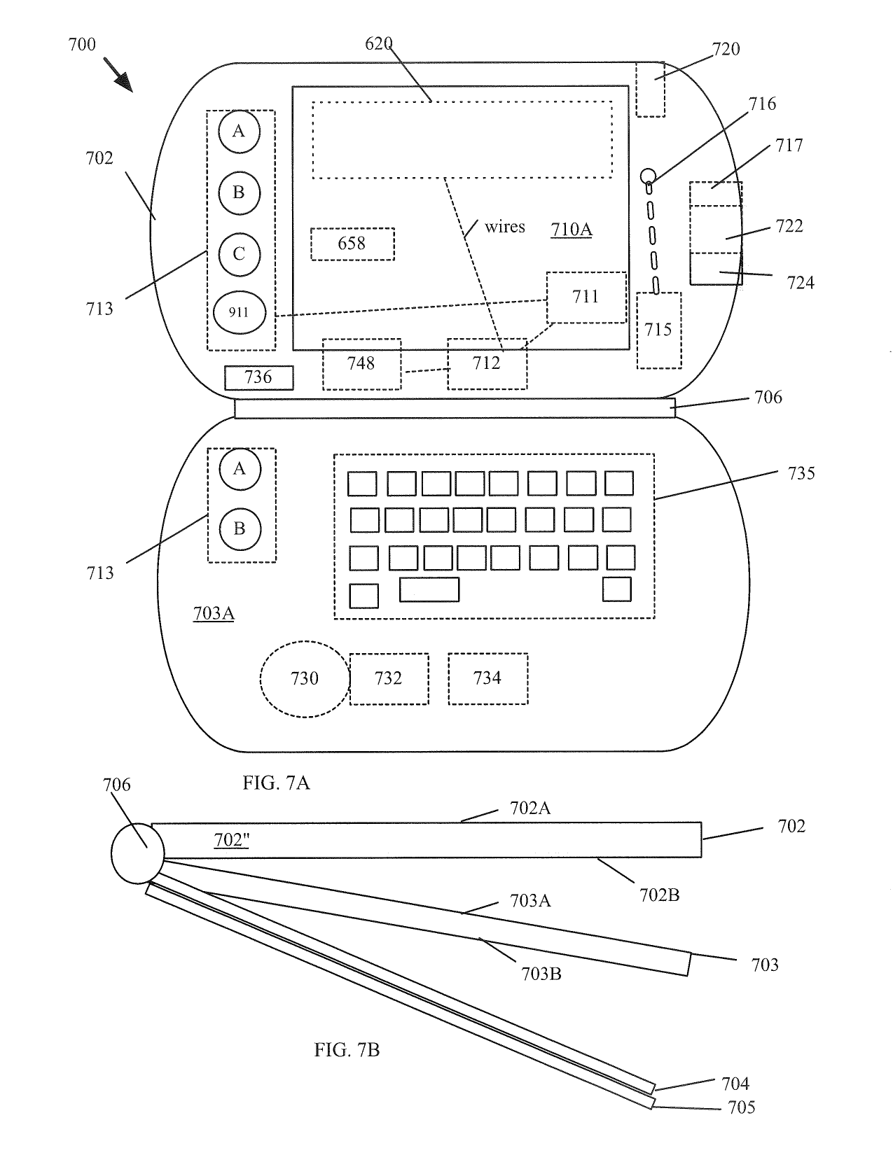

FIGS. 7A and 7B show a deck 700 having an electronic media display card (EMDC) 702 and having informational cards 703, 704, 705 on a spline 706 around which said card flip or rotate. The spline is connected to the EMDC at one edge. The EMDC has a core 702″ in which components are fitted as described in reference to FIGS. 6A-6C.

The (EMDC) 702 contains a display or screen 710, with a display face 710A which may be a liquid crystal display, a passive display, reflective, backlit or active. It may be an e-ink (electronic ink) screen also referred to as electrophoretic which is the optical component of a film used in Electronic Paper Displays (EPD). Such ink is commonly referred to as “bistable”. Bistable ink will retain an image on an E Ink screen even when all power sources are removed. E-ink has very low power consumption compared to other flat display types. The display 710 is powered by a battery 620 which also powers a controller 711 which includes at least a processor and will often include memory 712 or be connected to a memory storage device. The display is fitted within a cavity 550 in the EMDC. The back generally planar surface 703A of the EMDC faces away from the display face 710A and the generally planar front of the EMDC 702B contains the display. A laminate or cover 702 such as those described in reference to FIGS. 6A-6C is placed over the front of the EMDC 702B.

On at least one of EMDC 702 or adjacent card 703 having face of a card 703A interactive hand controls 713, such as buttons track pads, switches and the like are provided. Hand controls 713 such as buttons “A-E” may be used to navigate an on screen menu which the display can provide. An emergency button 714 (or “911” button) may be included. If the device 700 is to have wireless communication it will also contain a chipset 715 for transmission and/or reception of signal communications and an antenna 716. A Wi-Fi chip 748 may be included. A Wi-Fi chip set allows for wireless communication be it for the GPS location, data transmission or radio communications. A microphone 717 may be included. With a microphone a user may communicate via the radio functions of the device. The microphone may also be used as part of a voice recognition GUI to allow a user to verbally request content from the device. A “911” 714 button can be used to allow for one (or more) specific calls for user to report an incident or reach a designated person as needed. An I/O jack 718 may be provide for wired communication and data transmission with the device, A camera 719 may be added to allow a user to capture images. The camera may have its own memory 720 (which may be removable) an ear jack 722 may be provided. A power input 724 for recharging the battery can be provided or the battery may be replaceable. A second up battery 730 may be included. RFD tags 732 (active or passive) and/or GPS chips 734 may be added and powered by the battery power supply as needed. Optionally a keyboard 735 may be added for the user to interact with the server. RHO tags provided a simple wireless way to track the device. CPS provide another method for tracking the device and its location. An on/off switch or button 736 an optional close/open sensor may be provided. The close open sensor can be used to shut of specific functions when the deck is closed. Functions such as OPS, RFID for example may be left on. Components are placed within cavities 550 in the EMDC's core 702″. In some instances a video graphics card 658 which will include a processor and memory suitable for video display may be include if video images are to be displayed on the display.

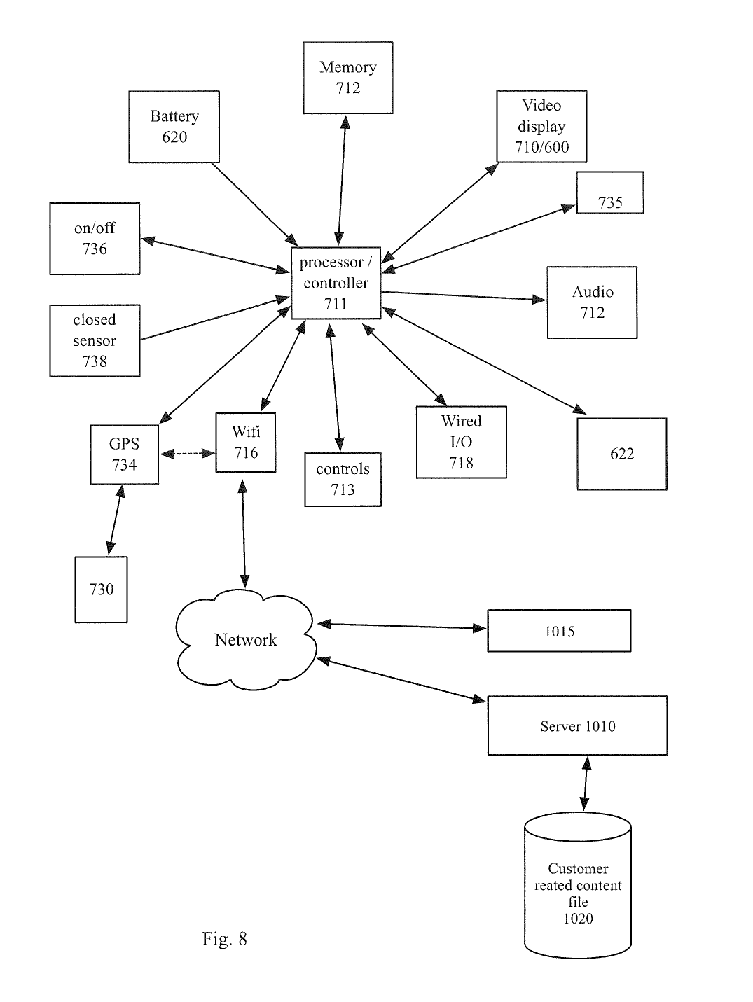

FIG. 8 is a diagram of a control scheme for an electronic deck 750. The controller/processor 711 is powered by a battery 620 and is in communications with the memory. The controller is also in communication with the sensors, fingerprint reader 622, audio output, the Wi-Fi chipset. It may be in communications with the GPS 734 or the GPS may have its own power supply battery 730 and its own connection to the Wi-Fi 716. The Wi-Fi 716 provides signal communication with a network 1000 whereby the device can be in signal communication with a server 1010 (or other computing device 1015). The server 1010 may be in communication with a database 1020. The device allows a user to request content and information to be displayed the display screen 710. Such content is one of streaming, in the memory of the device or to, in some instances, uploaded to the device, from a remote database via Wi-Fi, and stored or buffered in the device memory. Wi-Fi

[symbol]

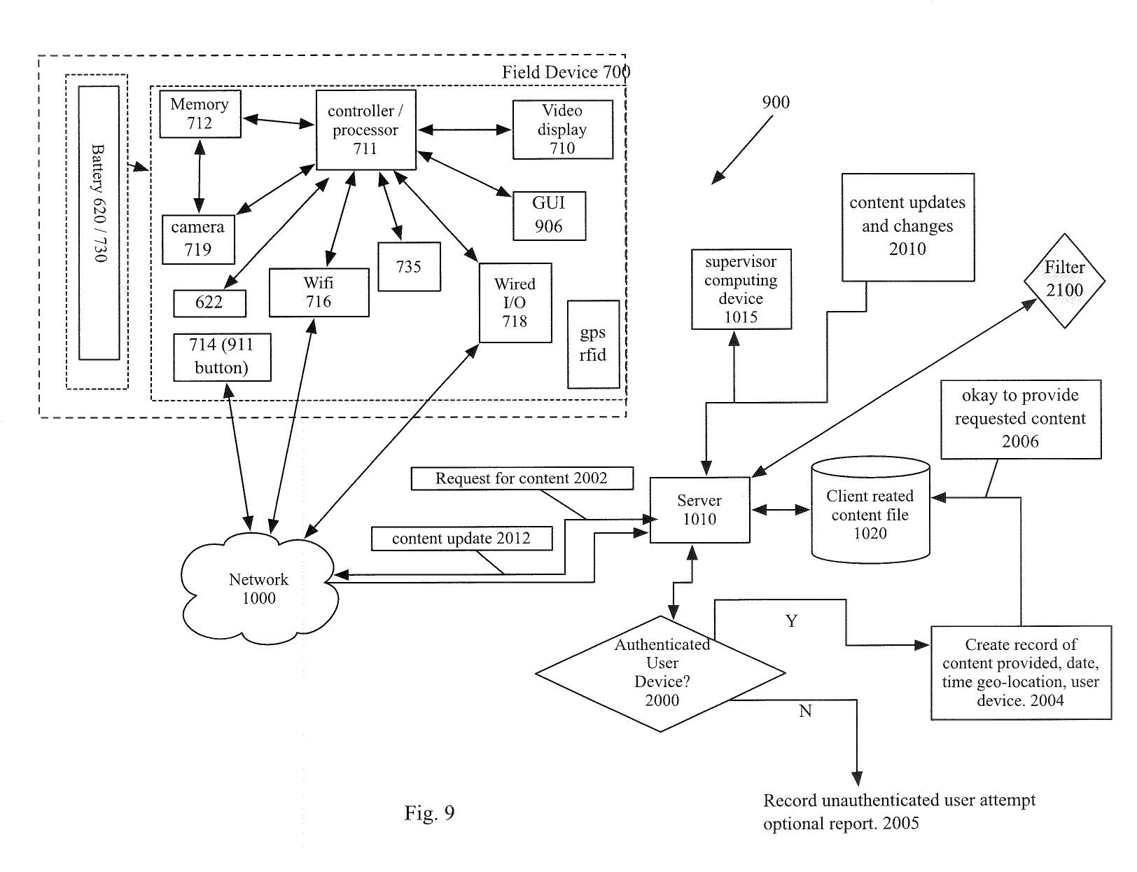

FIG. 9 is a flow diagram 900 of some aspects of an electronic deck. The display 710 is shown in signal communication with the processor/controller 711 and memory 712. The processor may also be in signal communications with the Wi-Fi 716 and or a wired I/O 718. The keyboard 735 and/or button controls 713 can be used for input as may a microphone 717 via voice command. The device 700 is in communications with a network 1000 which is in signal communication to a server 1010. The server is shown in communication with a database 1020, the server authenticates 2000 field devices seeking access to content/data.

When a communication between a in the field device 700 for information from a server 1010 takes place, in this example, the user field device requests content/information 2002 from the server 1010, first the server using rule and decision engines decisions if the user device is authenticated 2000 a record 2004 may be created of the device authentication, the GPS location of the device, the time, date and any user information or meta data associated with the communication. If the user device is not authenticated a record 2005 may be create of the failed attempt and a report may be made of the attempt. The authentication may be via fingerprint reader (622) or via device RFID tag or GPS or an optical image taken with a camera of user, or password or other means known in the art. If authenticated a user device's request for content 2002 may be filled via the server 1010 which may supply information form the database 1020.

A user utilizes a Graphical User Interface or GUI 902 to interact with the display 710 and processor to request content via a selection process. The controls allow the user to interact with the GUI and software/firmware of the processor and/memory allows the user to utilize the GUI and interact with the device. In this fashion a deck which in the past may require dozens of card may a few card of critical information useful if the device has no power or the display is not available to readable, and a display to supplement with volumes of information as may be needed or available. A computing device such as that used by a supervisor or content manager 1015 may be used within this system to update and change content 2010 from time to time. The server may push content updates 2012 to field device 700 on an as needed basis.

By having the server 1010 track the informational requests of one or more users utilizing a field deck, the content being requested may be observed and reported. The content requests may also be filtered 2100. The server can track key word requests by comparing with a look up table or other list of key words or topics. The server also tracks topic requests or content accessed. The filter uses rule and decision engines to examine the tracked data, including but not limited to keywords and topics, to at least one of identify each occurrence identify the number of occurrences, and identify a trend trends in a user or users requests for content. Key word or topic identification can be reported to supervisor or server may set alarms based on certain keywords or topics pursuant to a list the servers are comparing against. Alarms or reporting may be based on the volume of request meeting a threshold level. For example, in a construction operation if a significant portion of a population of users is requesting data on a particular topic or searching a particular keyword that could be indicative of a circumstance they are encountering which may be an early warning of a potential problem.

By having the server 1010 track the GPS position of field units any trend of movement of users towards an area may be indicative of a problem.

By having the server 1010 track the GPS position of field units members of a users having field units may be asked to capture images with the camera to allow at least one of the server or a supervisor to review visual images of something the users were directed to take pictures of. In this fashion one supervisor or sever may collect data from multiple users in the population and analyze circumstances and conditions from several points of view.

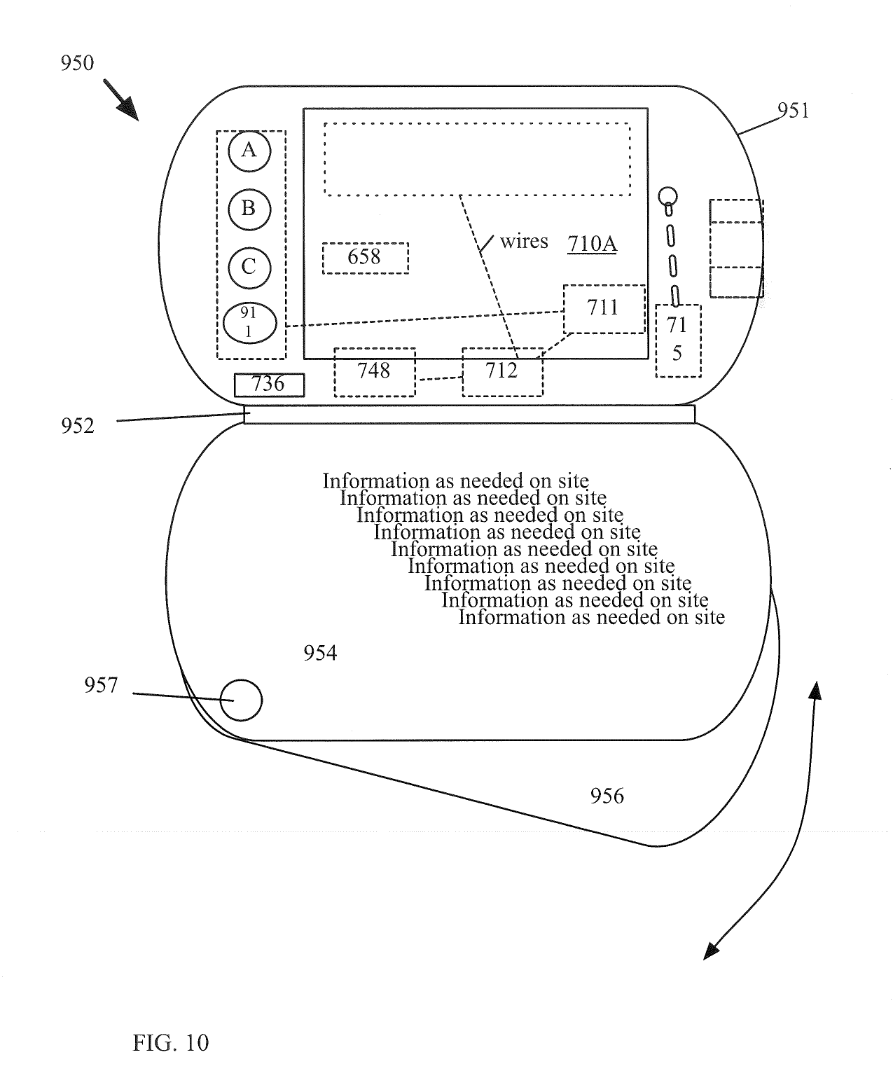

FIG. 10 shows a rotating and flipping informational deck 950. The exemplary implementation has aspects of both the rotating deck of cards described in FIGS. 1-6B and the deck which has a display that moves about a spline described in FIGS. 7A-7B. Media card 951 having a display electronics, battery, processor and the like (as described above) is connect via a hinge or spline 952 to a media connected fixed information card 954 which is part of a larger deck of cards 956 which rotate about a pivot 957. In this exemplar the pivot 957 may be removable thereby allowing updated or replacement pages to be added to the information card 954 affixed to the media card. In other instance the hinge or spline 952 is un attachable from the information card 954 thereby making the media card reusable with a different set of fixed While the method and apparatus have been described in terms of what are presently considered to be the most practical implementations and aspects thereof, it is to be understood that the disclosure need not be limited to the disclosed implementations, aspects or order and/or sequence of combination of aspects. It is intended to cover various modifications and similar arrangements included within the spirit and scope of the claims, the scope of which should be accorded the broadest interpretation so as to encompass all such modifications and similar structures. The present disclosure includes any and all implementations of the following claims.

It should also be understood that a variety of changes may be made without departing from the essence of the disclosure. Such changes are also implicitly included in the description. They still fall within the scope of this disclosure. It should be understood that this disclosure is intended to yield a patent covering numerous aspects both independently and as an overall system and in both method and apparatus modes.

Further, each of the various elements of the disclosure and claims may also be achieved in a variety of manners. This disclosure should be understood to encompass each such variation, be it a variation of an implementation of any apparatus implementation, a method or process implementation, or even merely a variation of any element of these.

Particularly, it should be understood that as the disclosure relates to elements of the implementation, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this disclosure is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all referenced listed in the Information Disclosure Statement or other information statement filed with the application are hereby appended and hereby incorporated by reference; however, as to each of the above, to the extent that such information or statements incorporated by reference might be considered inconsistent with the patenting, such statements are expressly not to be considered as made by the applicant(s).

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternatives.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

All callouts associated with figures are hereby incorporated by this reference.

Since certain changes may be made in the above system, method, process and or apparatus without departing from the scope of the disclosure herein involved, it is intended that all matter contained in the above description, as shown in the accompanying drawing, shall be interpreted in an illustrative, and not a limiting sense.

While various embodiments of the disclosure have been described, it will be apparent to those of ordinary skill in the art that many more embodiments and implementations are possible within the scope of this disclosure. Moreover, it will be understood that the foregoing description of numerous implementations has been presented for purposes of illustration and description. It is not exhaustive and does not limit the claimed disclosures to the precise forms disclosed. Modifications and variations are possible in light of the above description or may be acquired from practicing the disclosure. The claims and their equivalents define the scope of the disclosure. Accordingly, the disclosure is not to be restricted except in light of the attached claims and their equivalents.

1. A deck comprising:
a plurality of informational cards movably connected to each other via a spline (706);
an electronic media display card (EMDC) (702) with a core (702″), first cover (702A) over the core and a second cover (702B) over the core;
the spline connected to the EMDC at one edge;
a display (710) is fixed within a cavity (550) in the core;
a display face (710A) visible through the front cover of the EMDC;
at least the following electronic components are fixed in the core, wiring, a battery (620), processor (711), Memory 712), controls (713) and on/off switch (736); and,
wherein said display is connected via electrical wiring to the battery, processor, memory and controls.

2. The deck of claim 1, further comprising at least one of the following additional electrical components, radio (715) and antennae (716), Wi-Fi chip (748), GPS chip (734) and RFID (732).

3. The deck of claim 1, further comprising a keyboard (735).

4. The deck of claim 2, further comprising at least one of the following additional electrical components, microphone (717) and emergency “911” button (714).

5. The deck of claim 1, further comprising at least one of the following additional electrical components, ear jack (722), power input (724), and wired data I/O (718).

6. The deck of claim 2, further comprising at least one of the following additional electrical components, a second battery (730) and removable memory card (720)

7. The deck of claim 1 further comprising a video graphics card (658).

8. The deck of claim 1 further comprising one or more additional card affixed via a pivot (513) to one of the informational cards and wherein the additional card may be rotated about the pivot to display the information on the cards.

9. A rotatable deck comprising:
a plurality of informational cards connected to each other via a pivot;
a EMDC (510) with a front cover (511) and a back cover (511′) connect to the pivot;
a display (600) is fixed within a cavity (550) in the core (511″) of the EMDC;
the display face (600′) being visible through the front cover of the EMDC;
at least the following electronic components are fixed in the EMDC wiring, at least one processor/ controller (610), memory (615), a battery supply (620), and control interface (630)
wherein said display is connected via electrical wiring to the battery, processor, memory and control interface.

10. The deck of claim 9, further comprising at least one of the following additional electrical components optionally a finger print reader 622.

11. The deck of claim 10, further comprising at least one of the following additional electrical components, graphic card.

12. The deck of claim 9, further comprising at least one of the following additional electrical components, earphone jack (635), power plug-in (640) an I/O (645) and keyboard.

13. The deck of claim 9 wherein the display is an Electronic Paper Display.

14. The deck of claim 9 further comprising a keyboard.

15. A method of identifying risk at a job site, the method comprising:
a tracking the requests for content from multiple field devices to a server (1010);
create a record of each request (2004);
filter (2100) the requests for key words and specific topics; and,
report occurrence of key word or pre-selected topic request.

16. The method of claim 15, the method further comprising search a look-up table for key words and topics which should be reported.

17. The method of claim 15, the method further comprising only reporting keyword or topic occurrences if the number of content requests exceeds a threshold level.
